(19) United States
(12) Patent Application Publication
(10) Pub. No.: US 2023/0151161 A1
(43) Pub. Date: May 18, 2023

(54) METHOD AND SYSTEM FOR ODOUR ABATEMENT IN RUBBER PROCESSING

(71) Applicant: TYROMER INC., Toronto (CA)

(72) Inventor: Muhammad Umar FAROOQ, Kitchener (CA)

(21) Appl. No.: 17/916,868

(22) PCT Filed: Apr. 9, 2021
(86) PCT No.: PCT/CA2021/050479

§ 371 Date: Oct. 4, 2022

Related U.S. Application Data
(60) Provisional application No. 63/007,567, filed on Apr. 9, 2020.

(51) Int. Cl. C08J 3/20; C08C 19/08

(52) U.S. Cl. CPC C08J 3/203; C08C 19/08; C08J 3/201; C08J 2321/00

(57) ABSTRACT

Heating of rubber products during processing produces odours which may be abated by commingling the rubber product with fabric softener. The fabric softener may be commingled with the rubber product via a dip tank filled with fabric softener solution, by applying fabric softener to the rubber product prior to heating/processing the rubber product, by injecting the fabric softener into an extruder that is heating/processing the rubber product, and by treating the by-product exiting the side stream of the extruder.

### CROSS-REFERENCE TO OTHER APPLICATIONS

This document claims priority from U.S. Provisional Application No. 63/007,567 filed Apr. 9, 2020, which is hereby incorporated herein by reference.

### FIELD

The disclosure is generally directed at odour abatement in industrial applications, and more specifically, at a method and system for odour abatement in rubber processing.

### BACKGROUND

It is well known that heating rubber, for example, in tire manufacturing, typically produces an odour. Available commercial solutions for addressing this issue include activated carbon filters, chemical adsorbent and oxidation. While these can treat fugitive process emission, they do not control odour from the product which continues to emit odour as it off-gases in storage and transport.

In non-chemical devulcanization of waste rubber, vulcanized rubber crumb is continuously fed into a twin-screw extruder for thermomechanical conversion to elastomeric devulcanized rubber. The extrudate, as it exits the extruder, is hot and emits a strong odour. The odorous gases can be contained and put through an activated carbon filter which to some extent reduces the intensity of the odour. However, residual odour accumulation, particularly in workplaces with limited venting for air exchange, renders this strategy ineffective.

Another cause of odour is from the slow and persistent off-gassing of the devulcanized rubber in storage and in transport.

Therefore, there is provided a method and system for odour abatement that overcomes at least some of the disadvantages of current systems.

### SUMMARY

The present disclosure provides a novel method and system for odour abatement in industrial applications, such as, but not limited to, rubber processing. The disclosure assists to reduce the intensity of the odour in fugitive emission and/or to neutralize and reduce or prevent odour emission in storage and transport.

In one aspect of the disclosure, there is provided a method for odour abatement in industrial applications, the method including applying a fabric softener to rubber product.

In another aspect, the method further includes devulcanizing the rubber product. In yet another aspect, the method further includes providing a solution that includes between 2 and 10% fabric softener, wherein applying a fabric softener to the rubber product includes applying the solution to the rubber product. In a further aspect, applying a fabric softener to the rubber product includes applying a fabric softener to an extrudate. In yet a further aspect, applying a fabric softener to the rubber product includes passing the rubber product through a dip tank. In another aspect, the fabric softener includes an anti-tack agent. In an aspect, the fabric softener includes bleach.

In another aspect, devulcanizing the rubber product includes passing the rubber product through an extruder. In a further aspect, applying a fabric softener to the rubber product includes commingling the fabric softener and the rubber product within the extruder. In yet another aspect, applying a fabric softener to the rubber product includes dosing the rubber product with the fabric softener prior to passing the rubber product through the extruder. In another aspect, the method includes cooling the rubber product by coating with fabric softener and/or a fabric softener solution in water. In yet another aspect, cooling the rubber product occurs simultaneously with introducing the solution to the rubber product. In another aspect, the method further includes drying the rubber product. In another aspect, cooling the rubber product occurs simultaneously with drying the rubber product.

In another aspect of the disclosure, there is provided an apparatus for odour abatement, the apparatus including a dip tank to receive a rubber product and to hold a liquid including fabric softener; and a conveyor to convey the rubber product out of the dip tank.

In a further aspect, the apparatus further includes a dip tank liquid feeding apparatus.

In a further aspect of the disclosure there is provided an apparatus for odour abatement, the apparatus including an extruder having a feed inlet to receive a rubber product; and a liquid feeding apparatus coupled to the extruder to apply fabric softener to the rubber product.

In another aspect, the liquid feeding apparatus is coupled to the feed inlet to apply the fabric softener to the rubber product as the rubber product enters the extruder. In a further aspect, the liquid feeding apparatus is coupled to the extruder to commingle the fabric softener and the rubber product within the extruder. In yet another aspect, the apparatus includes a devolatilization outlet and a condenser, wherein the liquid feeding apparatus is coupled to the condenser to supply fabric softener to commingle with a condensate formed by the condenser. In yet another aspect, the apparatus further includes an activated carbon filter with a fabric softener wet pad.

### BRIEF DESCRIPTION OF THE DRAWINGS

The foregoing and other features and advantages of the disclosure will be apparent from the following description of embodiments thereof as illustrated in the accompanying drawings. The accompanying drawings, which are incorporated herein and form a part of the specification, further serve to explain the principles of the disclosure and to enable a person skilled in the pertinent art to make and use the invention. The drawings are not to scale.

FIG. 1 is a schematic view of an apparatus for odour abatement in industrial applications according to an embodiment herein;

FIG. 2 illustrates experimental results for an odour abatement test;

FIG. 3a is a flow diagram for a method for odour abatement in industrial applications according to an embodiment herein;

FIG. 3b is a flow diagram of another method for odour abatement in industrial applications according to an embodiment herein;

FIG. 3c is a flow diagram of yet another method for odour abatement in industrial applications according to an embodiment herein;

FIG. 4 is a schematic view of an apparatus for odour abatement in industrial applications according to another embodiment herein;

FIG. 5 is a schematic view of an apparatus for odour abatement in industrial applications according to another embodiment herein; and

FIG. 6 is a schematic view of an apparatus for odour abatement in industrial applications according to another embodiment herein.

### DETAILED DESCRIPTION

The present disclosure relates to a method and system for odour abatement in industrial applications, such as, but not limited to, rubber process. In one embodiment, the disclosure includes a novel use of a fabric softener (typically designed for treatment of fabrics during washing and/or drying) for industrial odour abatement. One advantage of the disclosure is that the application of the fabric softener product in the devulcanization of waste rubber provides at least one of odour suppression, abatement and encapsulation.

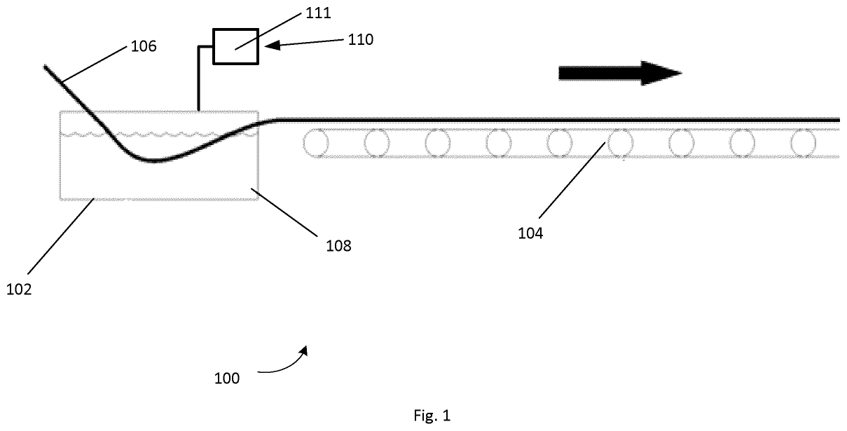

FIG. 1 is a schematic diagram of an apparatus for odour abatement 100. Apparatus 100 includes a dip tank 102, and a cooling conveyor 104. In operation, after a hot rubber product or a rubber extrudate 106 has been manufactured, for example by devulcanizing rubber, the rubber product 106 is passed through the dip tank 102 that includes a liquid 108 for cooling and treating the hot, devulcanized, rubber product 106. The liquid 108 within the dip tank 102 may be a fabric softener, including a combination of a liquid fabric softener, or a liquid having similar chemical properties to a fabric softener, and water. In other words, the liquid 108 may be a solution. In another embodiment, the liquid 108 may be a combination of water and a solid or powdered fabric softener that is dissolved into the water. In yet a further embodiment, the liquid 108 may be a combination of a fabric softener (either solid or liquid) mixed with a liquid that is approximately pH neutral to react with the fabric softener which typically has a pH of approximately 6. In some embodiments, the liquid 108 may include an anti-tack solution. In some embodiments, the liquid 108 may include bleach. The apparatus may further include a dip tank liquid feeding apparatus 110 for continuously filling the dip tank to maintain the level of the liquid 108 and/or the amount of fabric softener within the liquid 108 at a predetermined level or percentage. In the current embodiment, the dip tank liquid feeding apparatus 110 includes a reservoir 111 where the liquid may be mixed and then delivered or transported to the dip tank 102 via a series of pipes and pumps and/or other equipment. Alternatively, the fabric softener may be manually added to the dip tank 102 with the dip tank liquid feeding apparatus 110 supplying water for the liquid 108. In a specific embodiment, for a 150 L tank, the percentage of fabric softener within the liquid 108 may be between 3 and 10% by volume. Other percentages may be contemplated based on an intensity of the odor released by the rubber product or rubber extrudate.

In addition, depending on the industrial application or the level of odour abatement, the percentage level of fabric softener within the liquid 108 may be higher or lower than this range. Depending on the source fabric softener, whether it is commercial or industrial grade, based on the predetermined or desired percentage concentration of fabric softener in the liquid 108, the amount of commercial or industrial grade fabric softener that is needed to be added may be calculated. After being dipped in the dip tank 102, the rubber product 106 may then be passed to a packaging station via a conveyor belt, such as the cooling conveyor, or cooling conveyor belt 104.

In FIG. 1, the hot rubber product 106 is shown as a continuous strip, however, other forms, such as, but not limited to, a continuous rope of rubber, rubber chunks, rubber pellets or rubber slabs/sheets may be treated in a similar or different manner via the application of the liquid 108 to the hot rubber product. In some embodiments, where the hot rubber product 106 are chunks or pellets of rubber, the rubber product 106 may be dipped into the dip tank 102 and dragged up by a mesh conveyor onto the cooling conveyor 104.

In an alternative embodiment, fabric softener wet pads may be added to the odour abatement process, such as, after active carbon filters, that are currently used in odour abatement to improve odour abatement.

In a further embodiment, the liquid 108 containing fabric softener is sprayed onto the surface of the hot devulcanized rubber product 106 after it has been manufactured. The percentage concentration of the fabric softener within the liquid 108 is at a predetermined level based on the industrial application or level of odour abatement required. In this embodiment, the devulcanized rubber product 106 may be in the form of a continuous strip, rope, slabs/sheets, chunks, or pellets. The surface wetted devulcanized rubber product 106 is then dried and cooled for further processing or packaging.

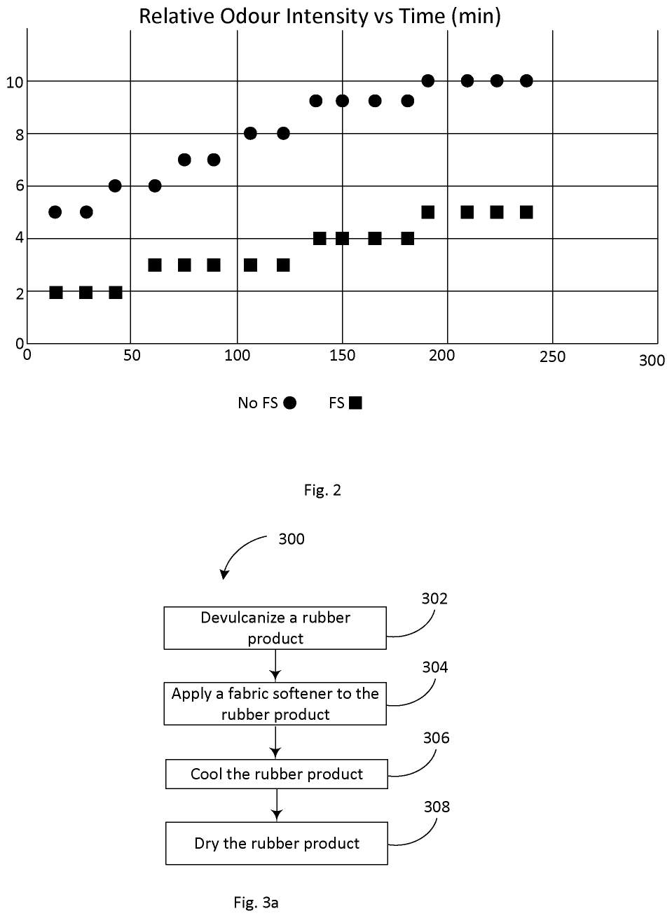

FIG. 2 is directed at a chart outlining experimental results of odour suppression by the use of a fabric softener in a production environment. The experiment was performed during a test production run of 250 minutes where waste tire rubber crumb was devulcanized at the rate of 500 kg/h. In this experiment, or test, the production space had only limited venting to the outside. Odour intensity, as agreed among production personnel, is presented qualitatively between 0 and 10 (the vertical axis) where 10 was rated as “unbearable”. The horizontal axis represents the time, in minutes, from production start. As can be seen, FIG. 2 shows that fabric softener is effective at odour suppression during rubber processing. Reduced odour intensity may allow for venting to the outside to further abate odour in the workplace.

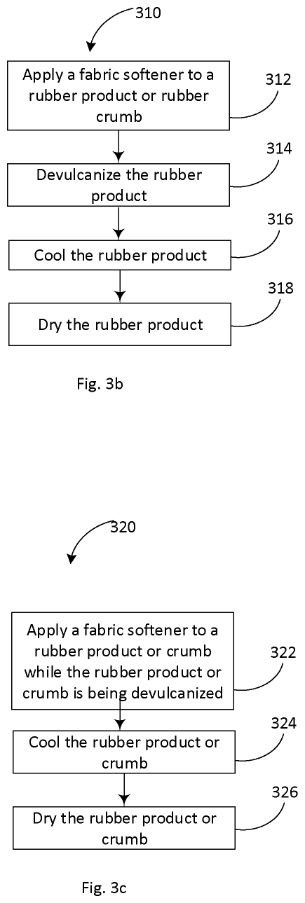

FIG. 3a is a flow diagram for a first embodiment of a method 300 for odour abatement during rubber processing is shown.

At 302, a rubber product, such as a rubber crumb, is devulcanized. Devulcanizing of the rubber crumb is a process where crosslinked chains/bonds are chemically broken, generating the odor that the current disclosure abates. Devulcanization of the rubber is thermomechanical process that also results in the rubber, being heated.

Devulcanization or heating the rubber crumb, or rubber product, may include passing the rubber crumb through an extruder, for example a twin-screw extruder. A non-exclusive example of rubber devulcanization is non-chemical devulcanization, which may include the use of supercritical carbon dioxide within an extruder.

At 304, a fabric softener is applied to the rubber product. Applying the fabric softener to the rubber product may include dipping the rubber product into the fabric softener or a liquid including the fabric softener (e.g. passing the rubber product through a dip tank), spraying the fabric softener or a liquid including the fabric softener onto the rubber product, or commingling the fabric softener and the rubber product. Spraying the fabric softener (or a solution including the fabric softener) onto the rubber product may also occur prior to or during heating or devulcanizing the rubber product as discussed below. The method may further include providing a solution that includes between 1 and 10% by volume fabric softener, although other percentage concentrations are contemplated, in which case applying the fabric softener to the rubber product includes applying the solution to the rubber product. If a solution including the fabric softener is placed within a dip tank, the dip tank may be refilled at regular time intervals in order to somewhat regularly maintain the predetermined percentage concentration of fabric softener within the solution. Depending on the industrial application that the odour abatement is being used for, further components, such as, but not limited to, an anti-tack liquid or bleach, may be added to the solution. The rubber product may come in different forms, such as, but not limited to, rubber crumb, a rubber extrudate, a continuous strip, a rope, rubber slabs/sheets, rubber chunks, or rubber pellets.

At 306, the method 300 may further include cooling the hot rubber product. In some embodiments, this cooling may occur when the hot rubber product is dipped into the dip tank. In other embodiments, the cooling may be done as the hot rubber product travels to a packaging station via a cooling conveyor belt, via fans, cooling tower with cyclone or via other known cooling processes after the fabric softener/solution is applied or sprayed onto the product. In some embodiments, the cooling may be done by applying more fabric softener/solution.

At 308, the method 300 may further include drying the rubber product. In some embodiments, the rubber product may be dried and cooled at the same time (i.e., simultaneously). In some other embodiments, the rubber product may be dried as it is being passed to a packaging station. The rubber product may also be air dried or passed through a dryer. In some embodiments, the cooled rubber product may be dried via exposure to moving air, warm air, forced air or via evaporation.

The odour abated rubber product may be passed for further processing such as to a packaging station.

Further specific examples of the use of fabric softener in odour abatement for industrial applications, such as, rubber processing, are discussed below.

### EXAMPLE 1

Referring to FIG. 1, 3 L of a commercial fabric softener, such as, but not limited to, Ultra Downy® Protect and Refresh™ Liquid Fabric Softener—Active Fresh was added to the dip tank containing 150 L of water to generate a solution 108. As the hot rubber product 106 passed through the solution 108, it warmed up the solution 108, applied coating to the rubber product 106 and dragged some of the solution 108 with it. In order to maintain the percentage concentration of fabric softener at the predetermined concertation within the solution 108, 3 L of fabric softener and 60 L of water may be added every hour to the dip tank 102 or the dip tank liquid feeding apparatus 110 to make up for solution loss.

### EXAMPLE 2

Again, referring to FIG. 1, 3 L of a commercial fabric softener, such as, but not limited to, Ultra Downy® Infusions™ Amber Blossom, was added to the dip tank 102 containing 150 L of water with 3% by weight Polycoat™ 323 HS (4), an industrial anti-tack agent that coats the rubber product 106 to prevent or reduce the likelihood of the rubber product 106 sticking to itself when piled up. In order to maintain the percentage concentration of fabric softener at the predetermined concertation within the solution 108, 3 L of fabric softener and 60 L of water containing 3% by volume anti-tack may be added every hour to make up for solution loss.

### EXAMPLE 3

Again, referring to FIG. 1, 3 L of a commercial fabric softener such as, but not limited to, Ultra Downy® Fabric Softener—Clean Breeze®, was added to the dip tank 102 containing 150 L of a solution 108 as in Example 2. To this solution 108 was added 2.4 L of a commercially available bleach. In order to maintain the percentage concentration of fabric softener at the predetermined concertation within the solution 108, 3 L of fabric softener and 60 L of water containing anti-tack, and 1.2 L of bleach were added to the dip tank 102, such as directly or via the dip tank liquid feeding apparatus 110 to make up for solution loss.

The addition of bleach further improved odour suppression as judged by the qualitative peer odour intensity assessment as shown in FIG. 2.

In all the examples above, the use of fabric softener significantly reduced the odour from continued off-gassing of the processed rubber product in storage.

In another embodiment, process vent gases may be treated with fabric softener for odour abatement, for example, in a scrubber application. In this application, the hot and odorous vent gas may be bubbled through a vessel containing a solution containing fabric softener. In another embodiment, for general workplace odour control or abatement, room air can be circulated through a filter pad continuously wetted with a solution including fabric softener at a predetermined percentage concentration.

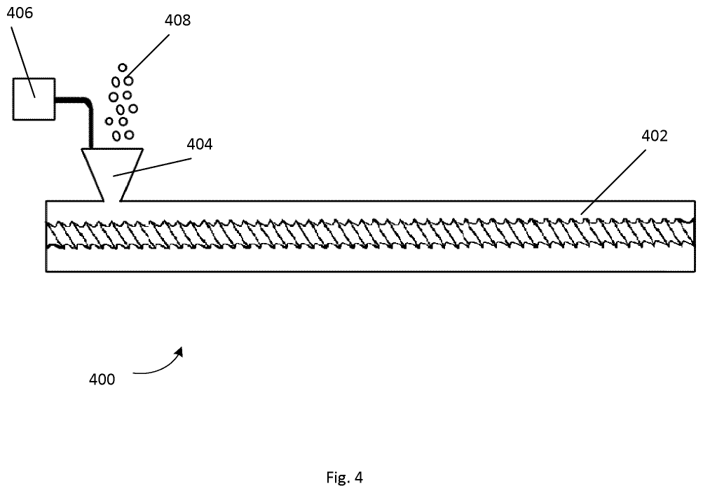

FIG. 4 is a schematic view of an apparatus 400 for odour abatement in industrial applications. Apparatus 400 includes an extruder 402, a feed inlet 404, and a liquid feeding apparatus 406. The liquid feeding apparatus 406 may be substantively similar to liquid feeding apparatus 110. In operation, a rubber product, such as, but not limited to rubber crumb 408 (for example, vulcanized rubber crumb) may be fed into feed inlet 404. The liquid feeding apparatus 406 applies fabric softener, for example a solution containing fabric softener, to the rubber crumb 408 as it enters the apparatus 400. The rubber, product or crumb 408 and the fabric softener are commingled within the apparatus 400, either within the feed inlet 404 or within the extruder 402. The extruder then heats and processes the rubber crumb, for example via non-chemical devulcanization. The commingling of the fabric softener and the rubber crumb 408 abates odours during and/or after heating and processing the rubber crumb.

The fabric softener may be applied to the rubber crumb 408 by spraying the fabric softener delivered by the liquid feeding apparatus into the feed inlet 404 such as via a set of pressurized jets or sprinklers. The fabric softener may be part of a solution, for example a solution containing water and 1 to 6% by volume liquid commercial fabric softener. The fabric softener may be delivered at a volume equal to up to 5% by weight, preferably 1% by weight.

Turning to FIG. 3b, another embodiment of a method 310 for odour abatement during rubber processing is shown. In this embodiment, fabric softener is applied to a rubber crumb 312. For example, such as with the apparatus of FIG. 4, the fabric softener is applied to the rubber crumb before it enters the extruder to be devulcanized, such as in the feed inlet.

In select embodiments where heating or devulcanizing the rubber crumb includes passing the rubber crumb through an extruder, applying the fabric softener to the rubber crumb may include applying (e.g. dosing) the fabric softener to rubber crumb prior to feeding the rubber crumb into the extruder or while feeding the rubber crumb into the extruder. In one embodiment, the fabric softener may be applied as a solution containing fabric softener at a volume of at least approximately 1 L of fabric softener/solution per 100 kg rubber crumb, i.e., 1% by weight. In alternative embodiments, the fabric softener may be applied and/or injected at a volume of up to 5% by weight.

The rubber crumb is then devulcanized 314. Again, with the apparatus of FIG. 4, the rubber crumb is devulcanized and/or heated as it passes through the extruder. After being devulcanized, the rubber product is then cooled 316 and/or dried 318. The cooling and drying may be performed as discussed above with 306 and 308.

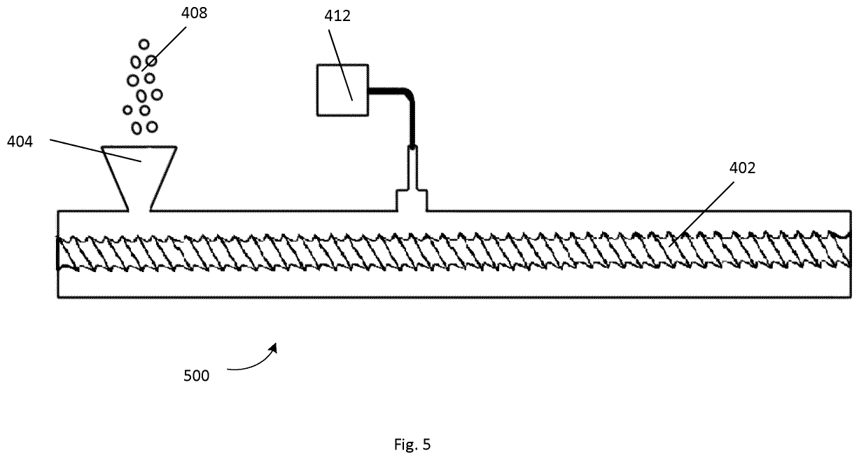

FIG. 5 is a schematic view of an apparatus 500 for odour abatement in industrial applications. Apparatus 500 is similar in some ways to apparatus 400, therefore the differences between apparatus 400 and apparatus 500 will be discussed in detail only. Apparatus 500 includes an extruder 402, a feed inlet 404, and a liquid feeding apparatus 412. The liquid feeding apparatus 412 is similar to the liquid feeding apparatus 406, however while the liquid feeding apparatus 406 applies fabric softener to the rubber product, or crumb 408 as the rubber crumb 408 enters the feed inlet 404, the liquid feeding apparatus 412 injects the fabric softener into the rubber crumb 408 while the rubber crumb 408 is within the extruder 402.

Turning to FIG. 3c, another embodiment of a method 320 for odour abatement during rubber processing is shown. In this embodiment, fabric softener is applied to a rubber crumb as the rubber crumb is being devulcanized 322. For example, such as with the apparatus of FIG. 5, the fabric softener is applied to the rubber crumb as it passes through the extruder. The fabric softener may be seen as being commingled with the rubber crumb. In this embodiment, the fabric softener can be seen as being injected into the extruder to apply the fabric softener to the rubber crumb.

In one embodiment, the fabric softener may be applied as a solution containing fabric softener at a volume of at least approximately 1 L of fabric softener/solution per 100 kg rubber crumb, i.e., 1% by weight. In alternative embodiments, the fabric softener may be applied and/or injected at a volume of up to 5% by weight.

After being devulcanized, the rubber product is then cooled 324 and/or dried 326. The cooling and drying may be performed as discussed above with 306 and 308.

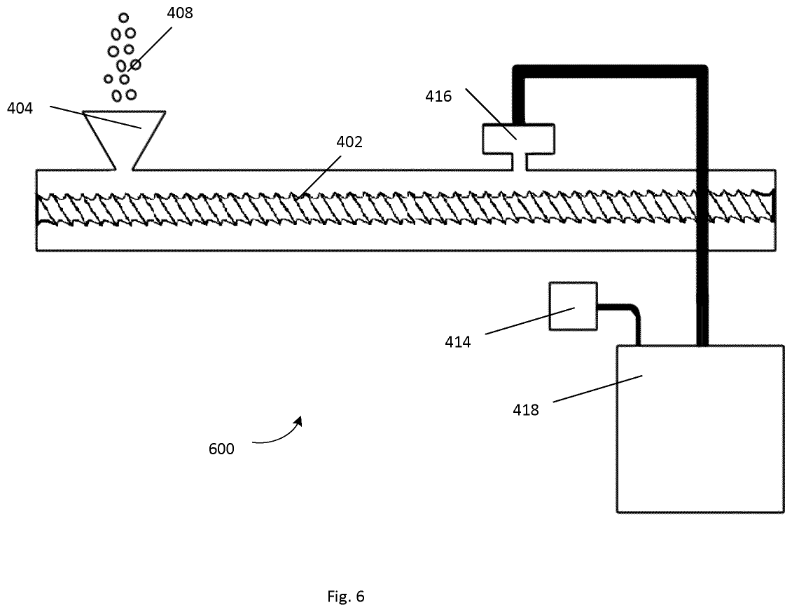

FIG. 6 is a schematic view of an apparatus 600 for odour abatement in industrial applications. Apparatus 600 is similar in some ways to apparatus 400 and apparatus 500. Apparatus 600 includes an extruder 402, a feed inlet 404, a liquid feeding apparatus 414, a devolatilization outlet 416, and a condenser 418. Devolatilization outlet 416 allows for devolatilization of the rubber crumb 408 by allowing volatile gases within the extruder 402 to exit the extruder and travel to condenser 418. Condenser 418 condenses the volatile gases to form a condensate. The liquid feeding apparatus 414 is similar to the liquid feeding apparatus 406 and 412, however instead of supplying fabric softener for commingling with the rubber crumb 408, the liquid feeding apparatus 414 supplies fabric softener for commingling with the condensate. The condensate, after commingling with the fabric softener, has an abated odour. The condenser 418 may have an outlet port to feed the volatile gases that did not condense in the condenser 418, to the activated carbon filter for further odor abatement. This activated carbon filter may include fabric softener as a wet pad to further assist in the odour abatement. Another addition to the condenser 418 might be addition of an oxidizer/combustion chamber in series to the condenser 418, which will burn off volatiles that burn at high temperatures.

A skilled person, having the benefit of the present disclosure, will appreciate that the above embodiments may be combined to provide enhanced odour abatement. For example, fabric softener may be commingled with the rubber product within an extruder that forms an extrudate. The extrudate may then be passed through a dip tank containing a solution of fabric softener, and additional solution may be sprayed onto the extrudate after the rubber product exits the dip tank.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding.

The above-described embodiments of the disclosure are intended to be examples of the present disclosure and alterations and modifications may be effected thereto, by those of skill in the art, without departing from the scope of the disclosure.

1. A method for odour abatement in industrial applications, the method comprising:
applying a fabric softener to rubber product.

2. The method of claim 1, further comprising devulcanizing the rubber product.

3. The method of claim 1, further comprising providing a solution that includes between 2 and 10% fabric softener, wherein applying a fabric softener to the rubber product includes applying the solution to the rubber product.

4. The method of claim 3, wherein applying a fabric softener to the rubber product includes applying a fabric softener to an extrudate.

5. The method of claim 3, wherein applying a fabric softener to the rubber product includes passing the rubber product through a dip tank.

6. The method of claim 1, wherein the fabric softener includes an anti-tack agent.

7. The method of claim 1, wherein the fabric softener includes bleach.

8. The method of claim 2, wherein devulcanizing the rubber product includes passing the rubber product through an extruder.

9. The method of claim 8, wherein applying a fabric softener to the rubber product includes commingling the fabric softener and the rubber product within the extruder.

10. The method of claim 8, wherein applying a fabric softener to the rubber product includes dosing the rubber product with the fabric softener prior to passing the rubber product through the extruder.

11. The method of claim 1, further comprising cooling the rubber product by coating with fabric softener and/or a fabric softener solution in water.

12. The method of claim 11, wherein cooling the rubber product occurs simultaneously with introducing the solution to the rubber product.

13. The method of claim 1, further comprising drying the rubber product.

14. (canceled)

15. An apparatus for odour abatement, the apparatus comprising:
a dip tank to receive a rubber product and to hold a liquid including fabric softener; and
a conveyor to convey the rubber product out of the dip tank.

16. The apparatus of claim 15 further comprising a dip tank liquid feeding apparatus.

17. An apparatus for odour abatement, the apparatus comprising
an extruder having a feed inlet to receive a rubber product; and
a liquid feeding apparatus coupled to the extruder to apply fabric softener to the rubber product.

18. The apparatus of claim 17, wherein the liquid feeding apparatus is coupled to the feed inlet to apply the fabric softener to the rubber product as the rubber product enters the extruder.

19. The apparatus of claim 17, wherein the liquid feeding apparatus is coupled to the extruder to commingle the fabric softener and the rubber product within the extruder.

20. The apparatus of claim 17, further comprising a devolatilization outlet and a condenser, wherein the liquid feeding apparatus is coupled to the condenser to supply fabric softener to commingle with a condensate formed by the condenser.

21. The apparatus of claim 17 further comprising an activated carbon filter with a fabric softener wet pad.
